(19) United States
(12) Patent Application Publication
(10) Pub. No.: US 2025/0226599 A1
(43) Pub. Date: Jul. 10, 2025

(54) HIGH-VOLTAGE AND HIGH-CURRENT CONNECTING DEVICE

(71) Applicant: Amphenol (Changzhou) Electronics Co., Ltd., Changzhou (CN)

(72) Inventors: Li Shenping, Guangzhou (CN); Li Heng, Changzhou, Jiangsu (CN); Wang Bei, Changzhou, Jiangsu (CN)

(21) Appl. No.: 19/013,353

(22) Filed: Jan. 8, 2025

(30) Foreign Application Priority Data
Jan. 9, 2024 (DE) 20 2024 100 076.5

(51) Int. Cl. H01R 4/70; H01R 4/30; H01R 11/26

(52) U.S. Cl. CPC H01R 4/70; H01R 4/30; H01R 11/26

(57) ABSTRACT

Rotary high-voltage and high-current connecting device has a plug and a socket. The socket has a connection unit, nut unit, insulating base, insulating cap, and contact protection cover. The plug has a connection unit, screw-like bolt unit, insulating base, and insulating cap. The nut unit is inserted into a concave structure of the socket insulating base. The socket connection unit is inserted into the insulating base and a copper sleeve is placed on the connection unit and the nut unit. Windows are provided on the insulating cap to lock with a detent structure of the socket insulating base. The contact protection cover is located on top of the nut unit. The insulating cap is joined with the plug insulating base via detent means and windows, while the plug is inserted into the socket by means of the nut unit and a bolt assembly.

The invention relates to a rotary high-voltage and high-current connecting device.

### TECHNICAL FIELD

This utility model relates to the technical field of high-current connecting devices, in particular to the technical field of a rotary high-voltage and high-current connecting device.

### Technical Background

The purpose of the connection in battery modules, storage systems, and energy boxes is to create a safe, stable, and effective electrical connection.

The connection between the battery modules is the connection between the energy storage system and the energy distribution box, and its purpose is to provide an effective, stable, and safe electrical connection in a limited installation space.

With the previous technology, the current level of plug and socket used for the electrical connection is exhausted, but the voltage level is low, and the mating space of plug and socket is greatly limited.

Therefore, plugs and sockets in this operating state should meet the following requirements: 1. Reliable connection. Due to the high torque loss—that is, low residual torque under complex and harsh working conditions—a secure connection is required; 2. Higher rated voltage and higher level of electrical safety; 3. More convenient and effective space utilization and greatly expanded range of application.

### Technical Description

The utility model aims to remedy disadvantages in the prior art and provides a rotary high-voltage, high-current connecting device.

In order to overcome the disadvantages of the previously known technology, the technical solution of the utility model is the rotary high-voltage and high-current connecting device comprising a socket and a plug, wherein the socket consists of a terminal assembly 1, a nut unit, an insulating base 1, an insulating cap 1, and a touch-safe cover, and the plug consists of an insulating cap 2, a bolt assembly, a terminal assembly 2, and an insulating base 2.

The nut unit is arranged in the concave structure of the insulating base 1, the terminal assembly 1 is arranged in the insulating base 1, and the copper sleeve is placed on the terminal assembly 1 and the nut unit, and then the insulating cap 1 is joined together with the insulating base 1.

A side plate is arranged on one side of the insulating cap 1, and an intermediate surface structure is arranged on the upper plane of the insulating cap 1, the side plate is covered on a positioning plate on one side of the insulating base 1, the square windows 1 are arranged at the edge of the other side of the insulating cap 1, the square windows 1 mate with and are connected to a button structure arranged on the other side of the insulating base 1; in addition, a touch-safe cover is mounted on the nut unit.

The interface 2 is located at the bottom of the insulating base, the positioning buttons are located on two sides of the insulating base, the terminal assembly 2 is inserted into the insulating base, and the bolt assembly passes through the middle hole of the terminal assembly 2; the insulating cap 2 is joined together with the insulating base 1 via the positioning buttons of the insulating base and the square windows 2 of the insulating cap.

The plug is inserted into the socket via the nut and bolt, and the electrical and physical connection is established.

According to another embodiment of the utility model, a positioning cylinder for positioning the nut unit is located in the center of the concave structure.

According to another embodiment of the utility model, the touch-safe cover has an annular convex structure connected to the annular slot of the nut unit.

According to another embodiment of the utility model, the petal-like structure in the socket interface and the plug interface provides the adapted property that the plug and socket can each be rotated, for example, by 30 or 36 degrees. It will readily be understood that other angles are also possible, and the utility model is not limited thereto.

The rotary high-voltage and high-current connecting device has the advantage that screws and nuts are made of high-performance steel, and the creepage distance is from 9.5 mm/min to 12 mm/max in this design. The plug connection has a petal-like interface structure, and the 30-degree rotary connection or the implemented rotary steps or the 36-degree rotary connection provide a large degree of freedom in the plug connection.

### DESCRIPTION OF THE FIGURES

In the following, this utility model is described in greater detail with reference to drawings 1 to 5 and the embodiment.

FIG. 1 is a schematic structural diagram of an exploded view of an embodiment of the socket of the plug connector.

FIG. 2 is a sectional view of the socket of the plug connector of the utility model.

FIG. 3 is the schematic view of the H-structure of the part in FIG. 2.

FIG. 4 is a schematic structural diagram of an exploded view of the plug 2 of the plug connector, and

FIG. 5 is a cross-sectional view of the plug.

### LIST OF REFERENCE SYMBOLS

1 electrical outlet (socket),
2 plug,
3 connection unit,
4 nut unit,
5 insulating base,
6 insulating cap,
7 contact protection cover,
8 insulating cap,
9 bolt assembly/bolt unit,
10 connection unit,
11 insulating base,
12 concave structure,
13 detent structure,
14 positioning cylinder,
15 square window/quadrangular window,
16 side plate,
17 positioning plate,
18 copper sleeve,
19 annular groove,
20 annular convex structure,
21 interface 1,
22 interface 2,
23 detent means,
24 square window.

### Description of Preferred Embodiments

As will readily be understood, the embodiments described constitute only an exemplary portion of the embodiments of the utility model and are not exhaustive of all embodiments. The scope of protection of the utility model includes the embodiments of the basic utility model and any and all other embodiments that a person skilled in the art gleans from the claim without inventive step.

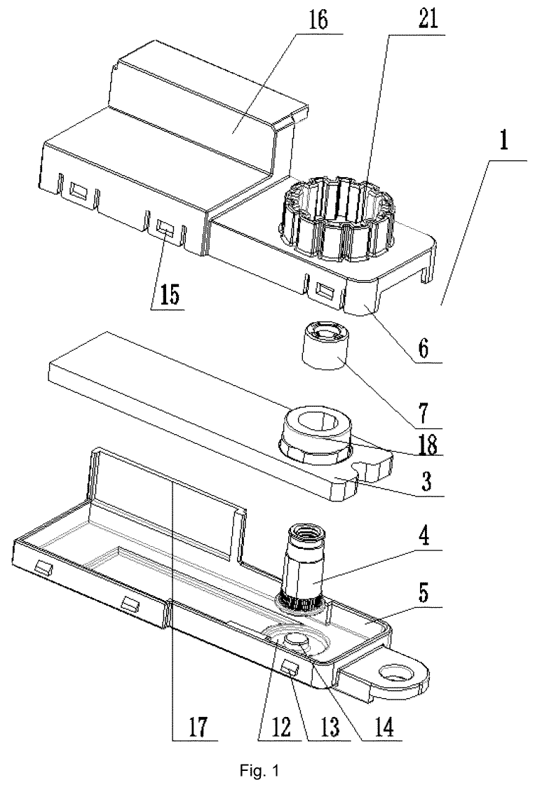

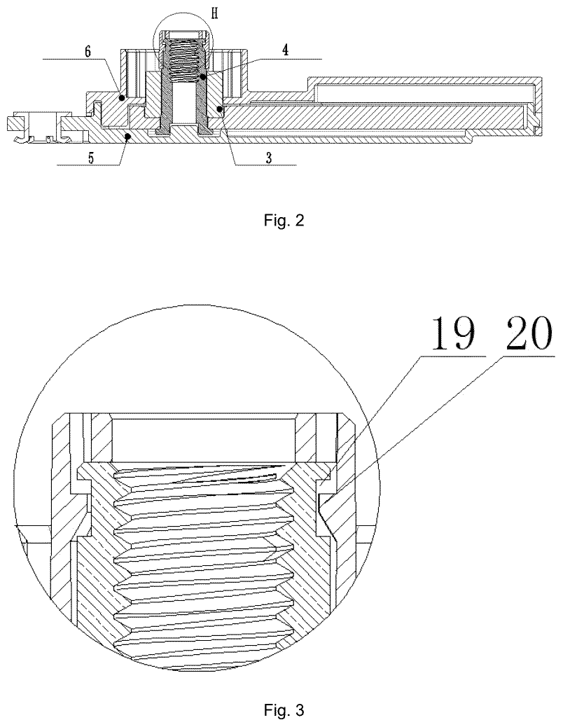

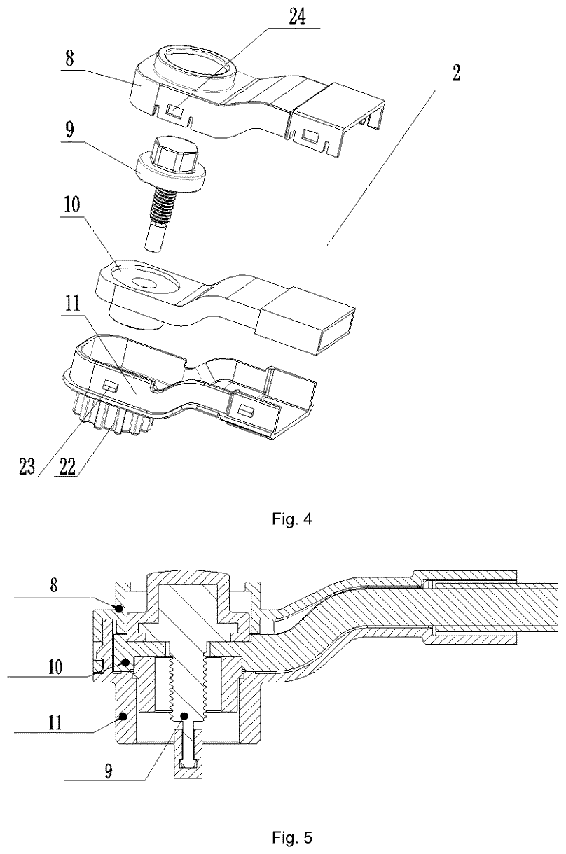

As shown in FIGS. 1 to 5, the electrical outlet/socket 1 consists of a connection unit 3, a nut unit/nut 4, an insulating base 5, an insulating cap 6, and a contact protection cover 7. The plug 2 consists of the insulating cap 8, the bolt assembly 9, the connection unit 10, and the insulating base 11.

The nut unit 4 is arranged in the concave structure 12 of the insulating base 5, the connection unit 3 is arranged in the insulating base 5, and the copper sleeve 18 is placed on the connection unit 3 and the nut unit 4, and then the insulating cap 6 is joined together with the insulating base 5. A side plate 16 is arranged on one side of the insulating cap 6, and the interface 21 is provided on the upper plane of the insulating cap 6, the side plate 16 is covered on a positioning plate 17 on one side of the insulating base 5, the square windows 15 are arranged at the edge of the other side of the insulating cap 6, the square windows 15 mate with and are connected to a latch structure 13 arranged on the other side of the insulating base 5, and a contact protection cover 7 is mounted on the nut unit 4.

The interface 22 is located on the bottom of the insulating base 11, the detent means 23 are located on two sides of the insulating base 11, the terminal assembly is inserted into the insulating base, and the bolt unit 9 is passed through the middle hole of the terminal assembly; the insulating cap 8 is connected to the insulating base 11 via the detent means 23 of the insulating base 11 and the square windows 24 of the insulating cap 8.

The plug 2 is inserted into the socket 1 via the nut 4 and the screwable bolt unit 9, whereby the electrical and physical connection is established.

When the plug 2 is connected to the socket 1, the interface 22 of the plug 2 is brought together with the interface 21 of the socket 1. The interface 21 and the interface 22 constitute a petal-like circular structure, and the engagement must be ensured during mating so that the bolt unit 9 of the plug 2 is inserted into the nut unit 4 of the socket 1 and the entire connection is able to perform a 30-degree turn or a 36-degree turn. This offers great freedom for customization.

The plug 2 and socket 1 are easy to connect together, and the plug 2 and socket 1 are fixed by positioning and clamping. When the plug and socket are joined together, the nut and screw are joined together with a certain torque in order to generate a large preload force, so that a stable, reliable, and effective connection is formed, the detent structure 13 of the plug and the connection unit 10 of the socket are securely joined together, and the high current-carrying capacity of from 200 A to 600 A can thus be achieved.

The positioning cylinder 14 for positioning the nut 4 is arranged in the center of the concave structure 12 in order to facilitate assembly and make the positioning more accurate. During the assembly process, the nut unit 4 need only be placed on the positioning cylinder 14, and then the detent structure 13 is placed in the windows 15 to complete the overall positioning of the nut unit 4.

The inside of the contact protection cover 7 is provided with an annular convex structure 20, and the annular convex structure 20 is clamped into the annular slot/groove 19 which is arranged at the upper end of the nut unit 4. The contact protection cover 7 can provide very good protection during the plugging process.

The interface 21 and the interface 22 constitute a petal-like circular structure, and the connection of the interface 21 and the interface 22 is a 30-degree turning pair or a 36-degree turning pair. This not only achieves a stable, reliable, and effective electrical connection, but also a multi-angle, rotary adjustment, which greatly improves the use of space.

The described representation constitutes only a preferred embodiment of this utility model.

1. A rotary high-voltage and high-current connecting device comprising a plug (2) and a socket (1), wherein the socket (1) consists of a connection unit (3), a nut unit (4), an insulating base (5), an insulating cap (6), and the contact protection cover (7) and the plug (2) consists of a connection unit (10), a screw-like bolt unit (9), an insulating base (11), and an insulating cap (8), characterized in that the nut unit (4) is inserted into a concave structure (12) of the insulating base (5) and the connection unit (3) is inserted into the insulating base (5) and a copper sleeve (18) is placed on the connection unit (3) and the nut unit (4), and the insulating cap (6) is joined together with the insulating base (5), the insulating cap (6) having a side plate (16) and an interface (21), the side plate (16) being joined together with a positioning plate (17) of the insulating base (5) and windows (15) being provided on the insulating cap (6) which lock with a detent structure (13) of the insulating base (5), and the contact protection cover (7) is located on top of the nut (4) and an interface (22) is located on the underside of the insulating base (11), further detent means (23) are located on two sides of the insulating base (11), the connection unit (10) is inserted into the insulating base (11), and the bolt assembly (9) protrudes through a central hole in the connection unit (10), the insulating cap (8) is joined together with the insulating base (11) via the detent means (23) and windows (24) of the insulating cap (8), while the plug (2) is inserted into the socket (1) by means of the nut unit (4) and the bolt assembly (9) and is connected there.

2. The rotary high-voltage and high-current connecting device according to claim 1, wherein a positioning cylinder (14) is formed in the center of the concave structure (12) in order to position the nut unit (4).

3. The rotary high-voltage and high-current connecting device according to claim 1, wherein the contact protection cover (7) has an annular convex structure (20), and this annular convex structure (20) is joined together with an annular slot (19) of the nut assembly (4).

4. The rotary high-voltage and high-current connecting device according to claim 1, wherein petal-like structures are formed in the interface (21) of the socket (1) and the interface (22) of the plug (1) such that plug and socket can be plugged together so as to be rotated by 30 or 36 degrees or corresponding steps relative to one another.
